(19) United States
(12) Patent Application Publication
(10) Pub. No.: US 2026/0277011 A1
(43) Pub. Date: Sep. 17, 2026

(54) BEAM SPLITTER AND BEAM SPLITTER MANUFACTURING METHOD

(71) Applicant: HAMAMATSU PHOTONICS K.K., Hamamatsu-shi, Shizuoka (JP)

(72) Inventors: Tomofumi SUZUKI, Shizuoka (JP); Tatsuya SUGIMOTO, Shizuoka (JP); Takuma OSAKI, Shizuoka (JP); Takafumi SEKO, Shizuoka (JP)

(73) Assignee: HAMAMATSU PHOTONICS K.K., Hamamatsu-shi, Shizuoka (JP)

(21) Appl. No.: 19/471,500

(22) PCT Filed: Mar. 28, 2024
(86) PCT No.: PCT/JP2024/012821

§ 371 Date: Oct. 1, 2025

(30) Foreign Application Priority Data
Apr. 4, 2023 (JP) 2023-060902

(51) Int. Cl. G02B 27/12; G02B 27/10

(52) U.S. Cl. CPC G02B 27/126; G02B 27/1073

(57) ABSTRACT

There is provided a beam splitter for branching incident light into a plurality of different components and emitting the components. The beam splitter includes a first light transmissive member that has a first surface and has transmissivity with respect to the incident light, a second light transmissive member that has a second surface and has transmissivity with respect to the incident light, an optical branching film that has a function of branching the incident light into the plurality of components, and an adhesive member configured to bond the first light transmissive member and the second light transmissive member. The first light transmissive member and the second light transmissive member are arranged such that the first surface and the second surface face each other with the optical branching film interposed therebetween.

### TECHNICAL FIELD

The present disclosure relates to a beam splitter and a beam splitter manufacturing method.

### BACKGROUND ART

Patent Literature 1 describes a cube-type non-polarizing beam splitter. In this non-polarizing beam splitter, a dielectric layer and a metal layer are sequentially coated on an inclined surface of a right-angled isosceles triangular prism as an incident medium. In addition, another right-angled isosceles triangular prism is bonded to the inclined surface of the right-angled isosceles triangular prism with these two-layer films interposed therebetween. TiO₂ and Ag are exemplified as materials of the dielectric layer and the metal layer, respectively.

### CITATION LIST

### Patent Literature

Patent Literature 1: Japanese Unexamined Patent Publication No. H01-092702

### SUMMARY OF INVENTION

### Technical Problem

In the non-polarizing beam splitter of Patent Literature 1, both the dielectric layer and the metal layer are provided so as to reach an outer edge of the inclined surface of the prism, and end portions thereof are exposed to an outer surface of the beam splitter. Thus, the metal layer may easily corrode due to contact with an atmosphere, and optical characteristics of the beam splitter may deteriorate.

An object of the present disclosure is to provide a beam splitter and a beam splitter manufacturing method capable of suppressing deterioration of optical characteristics.

### Solution to Problem

A beam splitter according to the present disclosure is [1] “a beam splitter for branching incident light into a plurality of different components and emitting the components, the beam splitter including a first light transmissive member that has a first surface and has transmissivity with respect to the incident light, a second light transmissive member that has a second surface and has transmissivity with respect to the incident light, an optical branching film that has a function of branching the incident light into the plurality of components, and an adhesive member configured to bond the first light transmissive member and the second light transmissive member, in which the first light transmissive member and the second light transmissive member are arranged such that the first surface and the second surface face each other with the optical branching film interposed therebetween, the optical branching film includes a first layer formed on the first surface, and a second layer stacked on the first surface and the first layer along a first direction intersecting the first surface, the second layer includes a first portion extending so as to cover an upper surface of the first layer on a side opposite to the first surface, a second portion connected to an end portion of the first portion in a second direction intersecting the first direction and extending along the first direction from the end portion of the first portion so as to cover a side surface of the first layer, and a third portion connected to an end portion of the second portion on a side opposite to a connection portion with the first portion and extending toward a side opposite to the first layer in the second direction, and the adhesive member includes a first adhesive portion arranged in a region facing the first portion of the second layer in a region sandwiched between the first surface and the second surface, and a second adhesive portion formed integrally with the first adhesive portion and arranged in a region facing the second portion and the third portion of the second layer in the region sandwiched between the first surface and the second surface”.

In this beam splitter, the first light transmissive member and the second light transmissive member are bonded to each other by the adhesive member in a state where the optical branching film is interposed therebetween. The optical branching film includes the first layer formed on the first surface of the first light transmissive member facing the second light transmissive member, and the second layer stacked on the first surface and the first layer. Then, the second layer includes the first portion extending so as to cover the upper surface of the first layer, the second portion extending from the first portion so as to cover the side surface of the first layer, and the third portion extending from the second portion toward the side opposite to the first layer. As described above, the side surface of the first layer is covered with the second layer at least in the region where the second portion is present. As a result, the side surface of the first layer is prevented from being exposed to the outside, and deterioration such as corrosion of the first layer is suppressed. In addition, the upper surface of the first layer is also covered with the first portion of the second layer. Thus, the deterioration such as corrosion of the first layer is also suppressed until the first light transmissive member and the second light transmissive member are bonded (at the time of manufacturing). Accordingly, according to the beam splitter, deterioration of optical characteristics is suppressed.

Note that, in this beam splitter, the second layer that contributes to the suppression of the deterioration of the first layer is the layer constituting the optical branching film. Accordingly, as compared with a case where the protective film is formed separately from the optical branching film, simplification of a manufacturing step, cost reduction, and the like can be achieved. Further, in the beam splitter, the adhesive member includes the first adhesive portion arranged in the region facing the first portion of the second layer in the region sandwiched between the first surface and the second surface, and the second adhesive portion arranged in the region facing the second portion and the third portion of the second layer in the region sandwiched between the first surface and the second surface. Thus, adhesion between the first light transmissive member and the second light transmissive member is strengthened.

A beam splitter according to the present disclosure may be [2] “the beam splitter according to the above [1], in which the optical branching film includes a third layer stacked on the first surface, the first layer, and the second layer along the first direction, the third layer includes a fourth portion extending so as to cover the first portion of the second layer, a fifth portion connected to an end portion of the fourth portion in the second direction and extending along the first direction from the end portion of the fourth portion so as to cover the second portion of the second layer, and a sixth portion connected to an end portion of the fifth portion on a side opposite to a connection portion with the fourth portion and extending toward a side opposite to the first layer in the second direction, and the sixth portion is arranged to face the third portion”. In this case, the side surface of the first layer is further covered with the third layer at least in the region where the second portion is present. In addition, the upper surface of the first layer is also further covered with the third layer. As a result, the deterioration such as corrosion of the first layer is reliably suppressed, and the deterioration of optical characteristics is reliably suppressed.

The beam splitter according to the present disclosure may be [3] “the beam splitter according to the above [2], in which the third layer is an oxide layer, and the third layer forms a surface of the optical branching film facing a side opposite to the first surface, and is in contact with the adhesive member”. In this case, oxidation of the second layer is suppressed until the first light transmissive member and the second light transmissive member are bonded (at the time of manufacturing).

The beam splitter according to the present disclosure may be [4] “the beam splitter according to any one of the above [1] to [3], in which the optical branching film includes a pair of fourth layers arranged so as to sandwich the first layer along the first direction, and a pair of fifth layers arranged so as to sandwich the first layer and the pair of fourth layers along the first direction, and the first portion of the second layer is formed on the fifth layer and is in contact with the fifth layer”. The optical branching film may have such a multilayer structure.

The beam splitter according to the present disclosure may be [5] “the beam splitter according to the above [4], in which the fourth layer is made of a first material, and the fifth layer is an oxide layer made of a material obtained by subjecting the first material to an oxidation treatment”. In this case, an increase in the absorption coefficient (reduction in reflectance and transmittance) due to the oxidation of the first layer can be suppressed. In addition, oxidation of the fourth layer can be suppressed until the second layer is formed (at the time of manufacturing).

The beam splitter according to the present disclosure may be [6] “the beam splitter according to the above [4] or [5], in which the fourth layer is made of one of Si, Ge, SiN, and ZnS, and the fifth layer is made of one of SiO₂, Al₂O₃, TiO₂, Y₂O₃, and Ta₂O₅”. The materials of the fourth layer and the fifth layer may be selected from these materials.

The beam splitter according to the present disclosure may be [7] “the beam splitter according to any one of the above [4] to [6], in which the fourth layer is made of the same material as the second layer”. In this case, the number of film formation sources can be reduced in manufacturing the optical branching film, and the optical branching film can be easily manufactured.

The beam splitter according to the present disclosure may be [8] “the beam splitter according to any one of the above [1] to [7], in which an outer edge of the first layer as viewed from the first direction includes short sides and long sides extending in a direction intersecting the short sides, and as viewed from the first direction, a distance between the short side and an outer edge of the first surface is larger than a distance between the long side and the outer edge of the first surface”. In this case, when the first light transmissive member and the second light transmissive member are bonded (at the time of manufacturing), even though positional displacement occurs in a direction intersecting the short side of the first layer, the first layer is suppressed from reaching the outer edge of the second surface and being exposed.

The beam splitter according to the present disclosure may be [9] “the beam splitter according to any one of the above [1] to [8], in which an outer edge of the first surface includes a first side facing an external member when the beam splitter is mounted on the external member, and the first layer extends such that a part of an outer edge of the first layer overlaps the first side as viewed from the first direction”. In this case, the first layer is formed wider, and a wider effective area can be formed. On the other hand, a part of the outer edge of the first layer reaches the first side of the outer edge of the first surface, and the first side is a side facing the external member when the beam splitter is mounted on the external member. Accordingly, a part of the outer edge of the first layer is prevented from being exposed to the outside.

The beam splitter according to the present disclosure may be [10] “the beam splitter according to any one of the above [1] to [9], in which a corner of the first layer as viewed from the first direction is formed in an arc shape”. In this case, even though the corner of the first light transmissive member or the second light transmissive member is chipped, the first layer is hardly exposed.

The beam splitter according to the present disclosure may be [11] “the beam splitter according to any one of the above [1] to [10], further including an incident surface of the incident light, and a third surface positioned on a side opposite to the incident surface via the first surface, the optical branching film, and the second surface, in which a reflection film configured to reflect light transmitted through the optical branching film is formed on the third surface”. In this case, the light transmitted through the optical branching film can be reflected in a predetermined direction.

The beam splitter according to the present disclosure may be [12] “the beam splitter according to any one of the above [1] to [11], further including an emission surface configured to emit light reflected by the optical branching film to an outside, in which an antireflection film is formed on the emission surface”. In this case, when the light reflected by the optical branching film is emitted, reflection on the emission surface is suppressed.

The beam splitter according to the present disclosure may be [13] “the beam splitter according to any one of the above [1] to [12], further including an incident surface of the incident light, in which an antireflection film is formed on the incident surface”. In this case, the reflection of the incident light on the incident surface is suppressed.

The beam splitter according to the present disclosure may be [14] “the beam splitter according to any one of the above [1] to [13], in which the first layer is made of a metal material, and the second layer is made of a semiconductor material or a dielectric material”. In this case, deterioration such as corrosion of the first layer made of a metal material is suppressed.

The beam splitter according to the present disclosure may be [15] “the beam splitter according to any one of the above [1] to [14], in which the first layer is made of Ag or Al, and the second layer is made of one of Si, Ge, SiO₂, SiN, Al₂O₃, Y₂O₃, Ta₂O₅, TiO₂, and ZnS”. In this case, deterioration such as corrosion of the first layer made of Ag or Al is suppressed.

A beam splitter manufacturing method according to the present disclosure is [16] “a beam splitter manufacturing method for manufacturing the beam splitter according to any one of the above [1] to [15] , the method including a first step of preparing a first member including a plurality of portions to be the first light transmissive members and a second member including a plurality of portions to be the second light transmissive members, a second step of forming the optical branching film on the first surface of each of the plurality of portions, which are included in the first member and become the first light transmissive member, after the first step, a third step of bonding the first member and the second member by the adhesive member via the optical branching film to form a structure including a plurality of the continuous beam splitters after the second step, and a fourth step of dividing the structure to obtain a plurality of the beam splitters from the structure after the third step”.

According to this method, it is possible to efficiently manufacture the beam splitter capable of suppressing the deterioration of optical characteristics.

The beam splitter manufacturing method according to the present disclosure may be [17] “the beam splitter manufacturing method according to the above [16], further including a fifth step of polishing a surface of the structure between the third step and the fourth step, in which the beam splitter includes a contact surface configured to come into contact with an external member when the beam splitter is mounted on the external member, and in the fifth step, at least a surface including a plurality of the contact surfaces in the structure is polished”. In this case, the contact surface of the beam splitter with the external member is flattened, and thus, the beam splitter can be easily mounted on the external member. In addition, in a case where the contact surface is the light emission surface of the beam splitter, it is possible to reduce variations in the optical path length from the incident surface to the emission surface by polishing the contact surface which is the emission surface.

### Advantageous Effects of Invention

According to the present disclosure, it is possible to provide the beam splitter and the beam splitter manufacturing method capable of suppressing deterioration of optical characteristics.

### BRIEF DESCRIPTION OF DRAWINGS

FIG. 1 is a sectional view illustrating an optical module according to one embodiment.

FIG. 2 is a sectional view illustrating a mirror unit and a beam splitter illustrated in FIG. 1.

FIG. 3 is a perspective view of the beam splitter illustrated in FIGS. 1 and 2.

FIG. 4 is a schematic sectional view taken along line IV-IV of FIG. 3.

FIG. 5 is a schematic view illustrating a case where a first surface and a first layer illustrated in FIG. 4 are viewed from a first direction.

FIG. 6 is a diagram illustrating one step of a beam splitter manufacturing method.

FIG. 7 is a diagram illustrating one step of the beam splitter manufacturing method.

FIG. 8 is a diagram illustrating one step of the beam splitter manufacturing method.

FIG. 9 is a schematic view illustrating a case where a first surface and a first layer according to a modification are viewed from a first direction.

### DESCRIPTION OF EMBODIMENTS

Hereinafter, one embodiment will be described with reference to the drawings. Note that, in the description of each drawing, the same or corresponding elements are denoted by the same reference signs, and redundant description may be omitted. In addition, each drawing may illustrate an orthogonal coordinate system that defines an X direction, a Y direction intersecting the X direction, and a Z direction intersecting the X direction and the Y direction. Alternatively, each drawing may illustrate another orthogonal coordinate system that defines a first direction D1, a second direction D2 intersecting the first direction D1, and a third direction D3 intersecting the first direction D1 and the second direction D2.

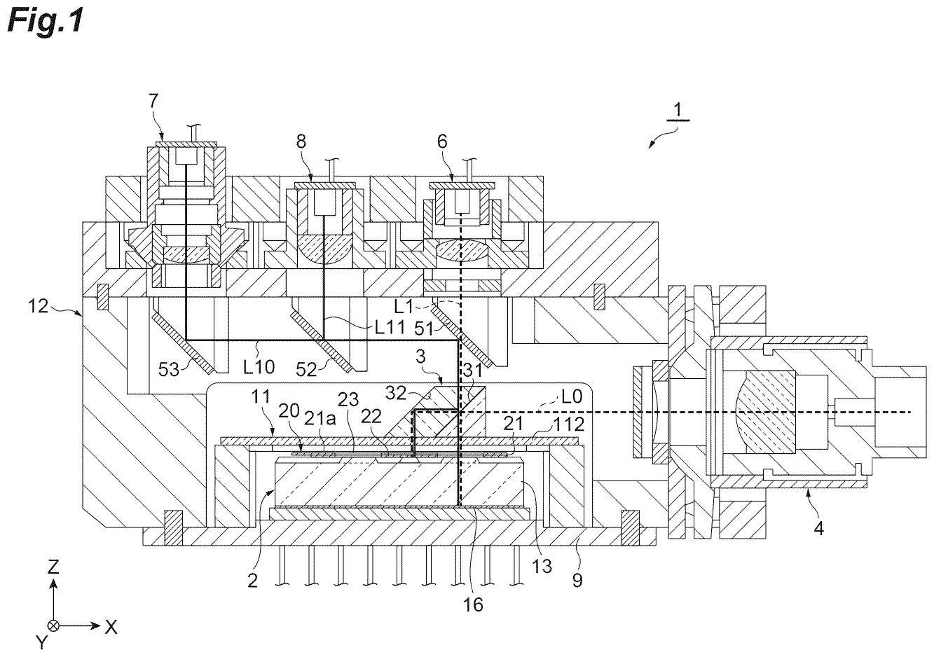

FIG. 1 is a sectional view illustrating an optical module according to one embodiment. As illustrated in FIG. 1, the optical module 1 includes a mirror unit 2, a beam splitter 3, a light incident unit 4, a first light detector 6, a second light source 7, a second light detector 8, a support 9, a first support structure 11, and a second support structure 12. The mirror unit 2 is arranged on one side of the support 9 in the Z direction, and is attached to the support 9 by, for example, an adhesive. The support 9 is made of, for example, copper tungsten, and has, for example, a rectangular plate shape. The mirror unit 2 includes a movable mirror 22 that moves along the Z direction and a fixed mirror 16 of which a position is fixed. Note that, the Z direction is, for example, a vertical direction, and one side in the Z direction is, for example, an upper side.

The beam splitter 3 is arranged on one side of the mirror unit 2 in the Z direction, and is supported by the first support structure 11. The first support structure 11 is attached to the support 9 by, for example, an adhesive. The light incident unit 4 is arranged on one side of the beam splitter 3 in the X direction, and is supported by the second support structure 12. The first light detector 6, the second light source 7, and the second light detector 8 are arranged on one side of the beam splitter 3 in the Z direction, and are supported by the second support structure 12. The second support structure 12 is attached to the support 9 by, for example, a bolt.

In the optical module 1, the beam splitter 3, the movable mirror 22, and the fixed mirror 16 constitute an interference optical system for each of measurement light L0 and laser light L10. The interference optical system provided for each of the measurement light L0 and the laser light L10 is, for example, a Michelson interference optical system.

For the measurement light L0, interference light L1 of the measurement light is detected as follows. That is, when the measurement light L0 incident from a first light source (not illustrated) through a measurement target (not illustrated) or the measurement light L0 (for example, light emission or the like of the measurement target itself) emitted from the measurement target is incident on the beam splitter 3 from the light incident unit 4, the measurement light L0 is divided into a part and a remaining part in the beam splitter 3. Then, a part of the measurement light L0 is reflected by the movable mirror 22 that reciprocates along the Z direction and returns to the beam splitter 3. On the other hand, the remaining part of the measurement light L0 is reflected by the fixed mirror 16 and returns to the beam splitter 3. A part and the remaining part of the measurement light L0 having returned to the beam splitter 3 are emitted from the beam splitter 3 as interference light L1, and the interference light L1 of the measurement light is detected by the first light detector 6.

As for the laser light L10, interference light L11 of the laser light is detected as follows. That is, when the laser light L10 emitted from the second light source 7 enters the beam splitter 3, the laser light L10 is divided into a part and the remaining part in the beam splitter 3. Then, a part of the laser light L10 is reflected by the movable mirror 22 that reciprocates along the Z direction and returns to the beam splitter 3. On the other hand, the remaining part of the laser light L10 is reflected by the fixed mirror 16 and returns to the beam splitter 3. A part and the remaining part of the laser light L10 having returned to the beam splitter 3 are emitted, as interference light L11, from the beam splitter 3, and the interference light L11 of the laser light is detected by the second light detector 8.

According to the optical module 1, a position of the movable mirror 22 in the Z direction can be measured based on a detection result of the interference light L11 of the laser light, and spectroscopic analysis of the measurement target can be performed based on a measurement result of the position and a detection result of the interference light L1 of the measurement light.

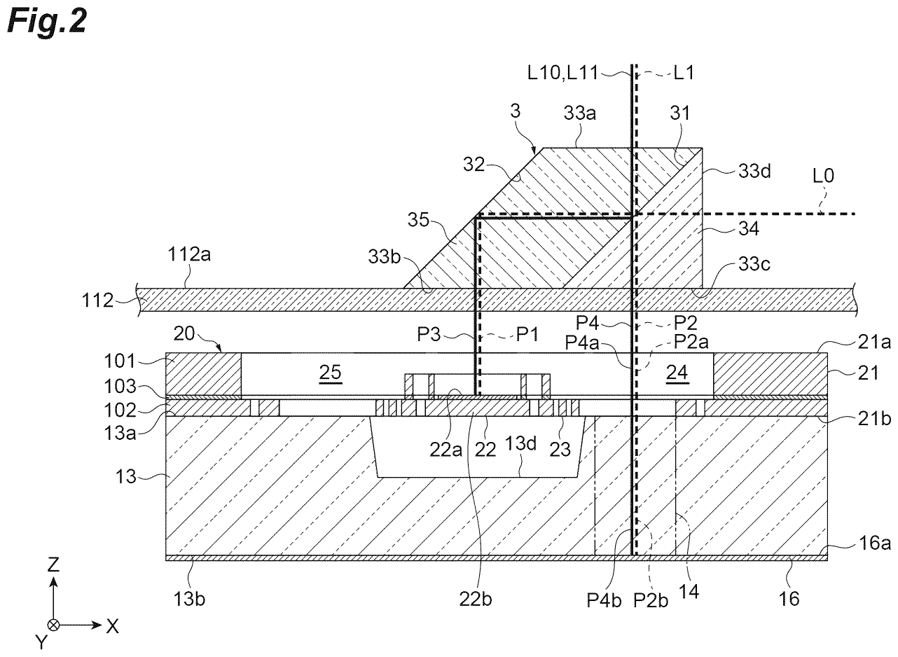

FIG. 2 is a sectional view illustrating the mirror unit and the beam splitter illustrated in FIG. 1. As illustrated in FIGS. 1 and 2, the beam splitter 3 is attached to a surface 112a of a light transmissive member 112 of the first support structure 11 on a side opposite to a mirror device 20 by, for example, an optical adhesive also serving as a refractive index matching agent.

The mirror device 20 is a part of the mirror unit 2. That is, the mirror unit 2 includes an optical function member 13, the fixed mirror 16, and the mirror device 20. The mirror device 20 includes a base 21, the movable mirror 22, and a drive unit 23. The base 21 has a first surface 21a (a surface on one side in the Z direction) and a second surface 21b on a side opposite to the first surface 21a. Each of the first surface 21a and the second surface 21b is a main surface of the base 21. The base 21 has, for example, a rectangular plate shape. The movable mirror 22 includes a mirror surface 22a and a movable portion 22b on which the mirror surface 22a is arranged. The movable mirror 22 is supported by the base 21 so as to be movable along the Z direction perpendicular to the first surface 21a. The drive unit 23 moves the movable mirror 22 along the Z direction.

A pair of light passing portions 24 and 25 is provided in the mirror device 20. The pair of light passing portions 24 and 25 is arranged on both sides of the movable mirror 22 in the X direction. The light passing portion 24 constitutes a first portion of an optical path between the beam splitter 3 and the fixed mirror 16.

The base 21, the movable portion 22b of the movable mirror 22, and the drive unit 23 are formed by, for example, a silicon on insulator (SOI) substrate. That is, the mirror device 20 is formed by an SOI substrate. The mirror device 20 is formed in, for example, a rectangular plate shape. The SOI substrate includes a support layer 101, a device layer 102, and an intermediate layer 103. The support layer 101 is a first silicon layer. The device layer 102 is a second silicon layer. The intermediate layer 103 is an insulating layer arranged between the support layer 101 and the device layer 102. The SOI substrate includes the support layer 101, the intermediate layer 103, and the device layer 102 in this order from one side in the Z direction.

The base 21 includes a part of the support layer 101, the device layer 102, and the intermediate layer 103. The first surface 21a of the base 21 is a surface of the support layer 101 on a side opposite to the intermediate layer 103. The second surface 21b of the base 21 is a surface of the device layer 102 on a side opposite to the intermediate layer 103. The support layer 101 constituting the base 21 is thicker than the device layer 102 constituting the base 21. A thickness of the support layer 101 constituting the base 21 is, for example, about 4 times a thickness of the device layer 102 constituting the base 21. In the mirror unit 2, as will be described later, the second surface 21b of the base 21 and a third surface 13a of the optical function member 13 are joined to each other.

In the mirror device 20, an electric signal for moving the movable mirror 22 along the Z direction is input to the drive unit 23 via a lead pin and a wire (not illustrated). Consequently, the movable mirror 22 can reciprocate at a resonance frequency level along the Z direction. As described above, the drive unit 23 functions as an electrostatic actuator.

The optical function member 13 has the third surface 13a (a surface on one side in the Z direction) facing the second surface 21b of the base 21, and a fourth surface 13b on a side opposite to the third surface 13a. The optical function member 13 is integrally made of a material having transmissivity with respect to measurement light L0 and the laser light L10. The optical function member 13 is formed in a rectangular plate shape by, for example, glass, and has a size of, for example, about 15 mm×20 mm×4 mm (thickness). Note that, as a material of the optical function member 13, depending on a sensitivity wavelength of the optical module 1, for example, glass is selected in a case where the sensitivity wavelength of the optical module 1 is in a near-infrared region, and silicon is selected in a case where the sensitivity wavelength of the optical module 1 is in a mid-infrared region.

A light transmissive portion 14 is provided in the optical function member 13. The light transmissive portion 14 is a portion of the optical function member 13 facing the light passing portion 24 of the mirror device 20 in the Z direction. A surface of the light transmissive portion 14 on the mirror device 20 side is positioned on the same plane as the third surface 13a. The light transmissive portion 14 constitutes a second portion (a part) of the optical path between the beam splitter 3 and the fixed mirror 16. The light transmissive portion 14 is a portion that corrects an optical path difference generated between an optical path between the beam splitter 3 and the movable mirror 22 and an optical path between the beam splitter 3 and the fixed mirror 16.

The optical function member 13 has a fifth surface 13d facing the movable mirror 22 and the drive unit 23 of the mirror device 20. The fifth surface 13d is positioned closer to the fourth surface 13b than the third surface 13a. Thus, the fifth surface 13d is separated from the mirror device 20 in a region facing the movable mirror 22 and the drive unit 23. In addition, a surface of the light transmissive portion 14 faces the light passing portion 24 of the mirror device 20. Consequently, in the mirror unit 2, when the movable mirror 22 reciprocates along the Z direction, the movable mirror 22 and the drive unit 23 are prevented from coming into contact with the optical function member 13.

The fixed mirror 16 is arranged on a side opposite to the mirror device 20 with respect to the optical function member 13, and a position of the fixed mirror 16 with respect to the base 21 of the mirror device 20 is fixed. The fixed mirror 16 is formed on the fourth surface 13b of the optical function member 13 by, for example, vapor deposition. The fixed mirror 16 has a mirror surface 16a perpendicular to the Z direction. In the present embodiment, the mirror surface 22a of the movable mirror 22 and the mirror surface 16a of the fixed mirror 16 face one side (the beam splitter 3 side) in the Z direction. Note that, the fixed mirror 16 is continuously formed on the fourth surface 13b of the optical function member 13 so as to reflect light transmitted through each light transmissive portion 14 of the optical function member 13.

The beam splitter 3 is attached to the surface 112a of the light transmissive member 112 on a side opposite to the mirror device 20 by, for example, an optical adhesive also serving as a refractive index matching agent. The beam splitter 3 has a first mirror surface 31, a second mirror surface 32, and a plurality of optical surfaces 33a, 33b, 33c, and 33d. The beam splitter 3 is formed by joining a plurality of optical blocks 34 and 35. Each of the optical blocks 34 and 35 is made of a material having a refractive index same as or similar to a refractive index of the optical function member 13.

The first mirror surface 31 is a mirror surface (for example, a half mirror surface) inclined with respect to the Z direction, and is formed between the optical block 34 and the optical block 35. In the present embodiment, the first mirror surface 31 is a surface parallel to the Y direction and forming an angle of 45° with the Z direction, and is a surface inclined so as to be away from the light incident unit 4 as approaching the mirror device 20. The first mirror surface 31 has a function of reflecting a part of the measurement light L0 and transmitting the remaining part of the measurement light L0, and a function of reflecting a part of the laser light L10 and transmitting the remaining part of the laser light L10. The first mirror surface 31 is made of, for example, a dielectric multilayer film. The first mirror surface 31 overlaps the light passing portion 24 of the mirror device 20, the light transmissive portion 14 of the optical function member 13, and the mirror surface 16a of the fixed mirror 16 as viewed from the Z direction, and overlaps the light incident unit 4 as viewed from the X direction (see FIG. 1). That is, the first mirror surface 31 faces the fixed mirror 16 in the Z direction and faces the light incident unit 4 in the X direction.

The second mirror surface 32 is a mirror surface (for example, a total reflection mirror surface) parallel to the first mirror surface 31, and is formed on the optical block 35 so as to be positioned on a side opposite to the light incident unit 4 with respect to the first mirror surface 31. The second mirror surface 32 has a function of reflecting the measurement light L0 and a function of reflecting the laser light L10. The second mirror surface 32 is made of, for example, a metal film. The second mirror surface 32 overlaps the mirror surface 22a of the movable mirror 22 of the mirror device 20 as viewed from the Z direction, and overlaps the first mirror surface 31 as viewed from the X direction. That is, the second mirror surface 32 faces the movable mirror 22 in the Z direction and faces the first mirror surface 31 in the X direction.

The optical surface 33a is a surface perpendicular to the Z direction, and is formed on the optical block 35 so as to be positioned on a side opposite to the mirror device 20 with respect to the first mirror surface 31. The optical surface 33b is a surface perpendicular to the Z direction, and is formed on the optical block 35 so as to be positioned on the mirror device 20 side with respect to the second mirror surface 32. The optical surface 33c is a surface perpendicular to the Z direction, and is formed on the optical block 34 so as to be positioned on the mirror device 20 side with respect to the first mirror surface 31.

The optical surface 33b and the optical surface 33c are positioned on the same plane. The optical surface 33d is a surface perpendicular to the X direction, and is formed on the optical block 34 so as to be positioned on the light incident unit 4 side with respect to the first mirror surface 31. Each of the optical surfaces 33a, 33b, 33c, and 33d has a function of transmitting the measurement light L0 and a function of transmitting the laser light L10. The beam splitter 3 having the above configuration is attached to the light transmissive member 112 by fixing the optical surface 33b and the optical surface 33c positioned on the same plane to the surface 112a of the light transmissive member 112 by, for example, an optical adhesive.

Here, an optical path of the measurement light L0 and an optical path of the laser light L10 in the mirror unit 2 and the beam splitter 3 will be described. When the measurement light L0 is incident on the beam splitter 3 along the X direction via the optical surface 33d, a part of the measurement light L0 is transmitted through the first mirror surface 31, is reflected by the second mirror surface 32, and reaches the mirror surface 22a of the movable mirror 22 via the optical surface 33b and the light transmissive member 112. A part of the measurement light L0 is reflected by the mirror surface 22a of the movable mirror 22, travels in an opposite direction on the same optical path P1, and is reflected by the first mirror surface 31.

The remaining part of the measurement light L0 is reflected by the first mirror surface 31 and reaches the mirror surface 16a of the fixed mirror 16 via the optical surface 33c, the light transmissive member 112, the light passing portion 24 of the mirror device 20, and the light transmissive portion 14 of the optical function member 13. The rest part of the measurement light L0 is reflected by the mirror surface 16a of the fixed mirror 16, travels in an opposite direction on the same optical path P2, and is transmitted through the first mirror surface 31. A part of the measurement light L0 reflected by the first mirror surface 31 and the remaining part of the measurement light L0 transmitted through the first mirror surface 31 become the interference light L1, and the interference light L1 of the measurement light is emitted from the beam splitter 3 along the Z-axis direction via the optical surface 33a.

On the other hand, when the laser light L10 is incident on the beam splitter 3 along the Z direction via the optical surface 33a, a part of the laser light L10 is reflected by the first mirror surface 31 and the second mirror surface 32, and reaches the mirror surface 22a of the movable mirror 22 via the optical surface 33b and the light transmissive member 112. A part of the laser light L10 is reflected by the mirror surface 22a of the movable mirror 22, travels in an opposite direction on the same optical path P3, and is reflected by the first mirror surface 31.

The remaining part of the laser light L10 is transmitted through the first mirror surface 31, and reaches the mirror surface 16a of the fixed mirror 16 via the optical surface 33c, the light transmissive member 112, the light passing portion 24 of the mirror device 20, and the light transmissive portion 14 of the optical function member 13. The remaining part of the laser light L10 is reflected by the mirror surface 16a of the fixed mirror 16, travels in an opposite direction on the same optical path P4, and is transmitted through the first mirror surface 31. A part of the laser light L10 reflected by the first mirror surface 31 and the remaining part of the laser light L10 transmitted through the first mirror surface 31 become the interference light L11, and the interference light L11 of the laser light is emitted from the beam splitter 3 along the Z direction via the optical surface 33a.

As described above, the light passing portion 24 of the mirror device 20 constitutes a first portion P2a of the optical path P2 of the measurement light L0 and a first portion P4a of the optical path P4 of the laser light L10 in the optical path between the beam splitter 3 and the fixed mirror 16. In addition, the light transmissive portion 14 of the optical function member 13 constitutes a second portion P2b of the optical path P2 of the measurement light L0 and a second portion P4b of the optical path P4 of the laser light L10 in the optical path between the beam splitter 3 and the fixed mirror 16.

Since the second portion P2b of the optical path P2 of the measurement light L0 is formed by the light transmissive portion 14, an optical path difference between the optical paths P1 and P2 is corrected such that a difference between an optical path length of the optical path P1 of the measurement light L0 (an optical path length considering a refractive index of each medium through which the optical path passes) and an optical path length of the optical path P2 of the measurement light L0 becomes small. Similarly, since the second portion P4b of the optical path P4 of the laser light L10 is formed by the light transmissive portion 14, an optical path difference between the optical paths P3 and P4 is corrected such that a difference between an optical path length of the optical path P3 of the laser light L10 and an optical path length of the optical path P4 of the laser light L10 becomes small. In the present embodiment, a refractive index of the light transmissive portion 14 is equal to a refractive index of each optical block constituting the beam splitter 3, and a distance between the first mirror surface 31 and the second mirror surface 32 along the X direction is equal to the thickness (that is, a distance between the surface of the light transmissive portion 14 and the fourth surface 13b of the optical function member 13 along the Z direction) of the light transmissive portion 14 along the Z direction.

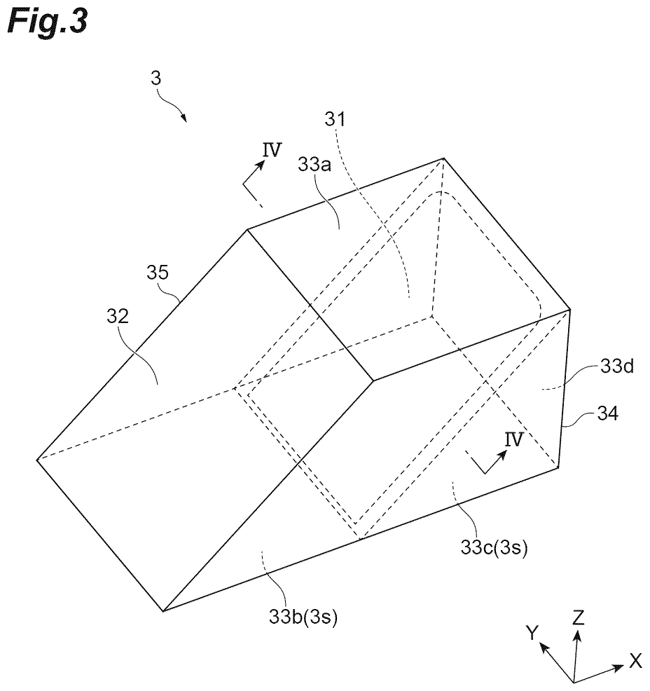

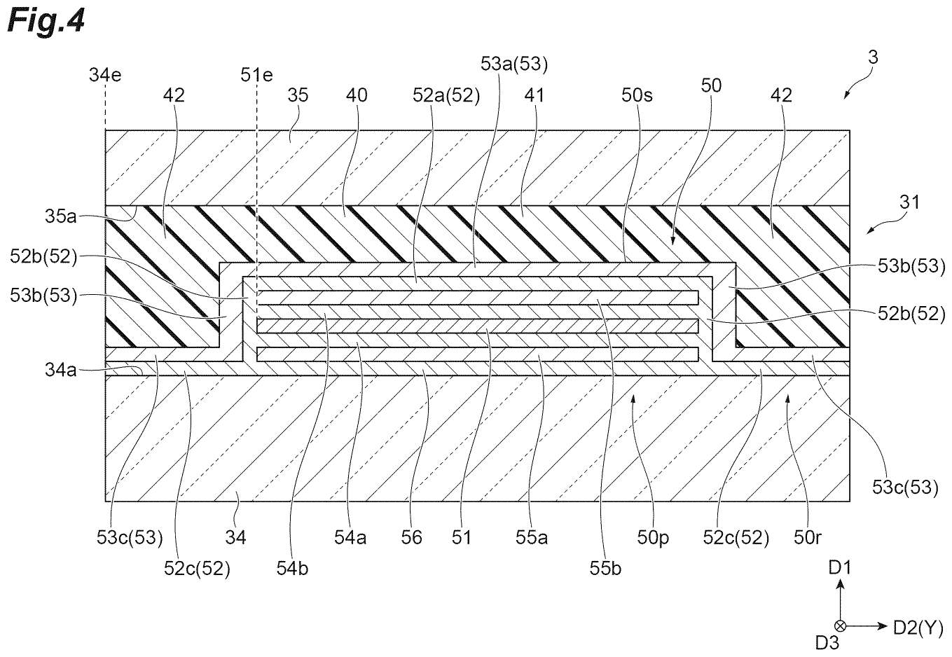

Next, details of the beam splitter 3 will be described. FIG. 3 is a perspective view of the beam splitter illustrated in FIGS. 1 and 2. FIG. 4 is a sectional view taken along line IV-IV of FIG. 3. As described above, the beam splitter 3 illustrated in FIGS. 3 and 4 branches the incident light (the measurement light L0 and the laser light L10) into a plurality of different components (a part and the remaining part of the measurement light L0 and a part and the remaining part of the laser light L10) and emits the components. Thus, the beam splitter 3 includes the optical block 34 (first light transmissive member), the optical block 35 (second light transmissive member), an adhesive member 40, and an optical branching film 50. Note that, the beam splitter 3 may function as a half mirror that equally divides the incident light into light on a transmission side and light on a reflection side.

The optical block 34 has a first surface 34a and has transmissivity with respect to the incident light. In the present embodiment, the optical block 34 is formed in a triangular prism shape having a pair of right triangular end surfaces parallel to each other, and the first surface 34a is a side surface (inclined surface) that connects the optical surface 33d and the optical surface 33c substantially orthogonal to each other in the optical block 34. The optical block 35 has a second surface 35a and has transmissivity with respect to the incident light. In the present embodiment, the optical block 35 is formed in a quadrangular prism shape having a pair of parallelogram-shaped end surfaces parallel to each other, and the second surface 35a is a side surface (inclined surface) that connects the optical surface 33a and the optical surface 33b parallel to each other in the optical block 35.

The optical block 34 and the optical block 35 are arranged such that the first surface 34a and the second surface 35a face each other. The adhesive member 40 has transmissivity with respect to the incident light and is arranged between the first surface 34a and the second surface 35a. The optical branching film 50 is arranged between the first surface 34a and the second surface 35a, and has a function of branching the incident light into a plurality of components. Note that, in a case where the beam splitter 3 functions as the half mirror, the optical branching film 50 has a function of equally dividing the incident light into the light on the transmission side and the light on the reflection side.

Accordingly, the optical block 34 and the optical block 35 are arranged such that the first surface 34a and the second surface 35a face each other with the adhesive member 40 and the optical branching film 50 interposed therebetween, and are bonded to each other by the adhesive member 40. Consequently, in the present embodiment, the beam splitter 3 is formed in a quadrangular prism shape having a pair of trapezoidal end surfaces parallel to each other as a whole. The adhesive member 40 and the optical branching film 50 constitute the first mirror surface 31 described above. That is, the first surface 34a is a surface of the optical block 34 facing the first mirror surface 31, and the second surface 35a is a surface of the optical block 35 facing the first mirror surface 31. The first surface 34a and the second surface 35a are substantially parallel to each other.

The first direction D1 is a direction intersecting (orthogonal to) the first surface 34a and the second surface 35a. The first direction D1 is inclined by, for example, 45° with respect to the Z direction. Accordingly, the first surface 34a and the second surface 35a are also inclined by, for example, 45° with respect to the Z direction. The second direction D2 is a direction intersecting (orthogonal to) the first direction D1 and is along the first surface 34a and the second surface 35a. Here, the second direction D2 coincides with the Y direction. The third direction D3 is a direction intersecting (orthogonal to) the first direction D1 and the second direction D2 and is along the first surface 34a and the second surface 35a. The third direction D3 is inclined by, for example, 45° with respect to the X direction.

The optical branching film 50 is formed on the first surface 34a (or may be formed on the second surface 35a) as an example, and includes a plurality of layers stacked along the first direction D1 (has a multilayer film structure). More specifically, the optical branching film 50 includes a first layer 51 formed on the first surface 34a, and a second layer 52 stacked on the first surface 34a and the first layer 51 along the first direction D1. Further, in the present embodiment, the optical branching film 50 includes a third layer 53 stacked on the first surface 34a, the first layer 51, and the second layer 52 along the first direction D1, a pair of fourth layers 54a and 54b arranged so as to sandwich the first layer 51 along the first direction D1, and a pair of fifth layers 55a and 55b arranged so as to sandwich the first layer 51 and the fourth layers 54a and 54b along the first direction D1.

Consequently, in a main portion (effective area 50p) including a center of the optical branching film 50, the fifth layer 55a, the fourth layer 54a, the first layer 51, the fourth layer 54b, the fifth layer 55b, the second layer 52, and the third layer 53 are stacked in this order from the first surface 34a side. A first portion 52a of the second layer 52 is formed on the fifth layer 55b and is in contact with the fifth layer 55b. Among these layers, layers adjacent to each other are in contact with each other. Note that, the optical branching film 50 includes a base layer 56 coming into contact with the first surface 34a, and each of the above layers is stacked on the base layer 56.

The first layer 51 has a rectangular shape as viewed from the first direction D1. The first layer 51 is a flat layer and covers the entire surface of the base layer 56 as viewed from the first direction D1. The first layer 51 is made of, for example, a metal material such as Ag or Al.

The second layer 52 has a rectangular shape as viewed from the first direction D1. The second layer 52 covers the first layer 51 and extends on the first surface 34a beyond an outer edge 51e of the first layer 51 as viewed from the first direction D1. The second layer 52 is in contact with the first surface 34a in a portion beyond the outer edge 51e of the first layer 51. More specifically, the second layer 52 includes the first portion 52a, a second portion 52b, and a third portion 52c. The first portion 52a is a portion extending so as to cover an upper surface of the first layer 51 on a side opposite to the first surface 34a. The first portion 52a covers the first layer 51 as viewed from the first direction D1.

The second portion 52b is connected to an end portion of the first portion 52a in the second direction D2, and extends along the first direction D1 from the end portion of the first portion 52a so as to cover a side surface (here, a surface intersecting the second direction D2) of the first layer 51. In the present embodiment, the second portion 52b extends so as to cover side surfaces of the fourth layers 54a and 54b, the fifth layers 55a and 55b, and the base layer 56 in addition to the side surface of the first layer 51, and reaches the first surface 34a. The third portion 52c is connected to an end portion of the second portion 52b on a side opposite to a connection portion with the first portion 52a, and extends toward a side (outside) opposite to the first layer 51 in the second direction D2 (and the third direction D3). The third portion 52c is in contact with the first surface 34a. Consequently, in the second layer 52, a step is formed between the first portion 52a and the third portion 52c. Note that, the second portion 52b is connected to the first portion 52a and the third portion 52c at an end portion of the second portion 52b in the first direction D1.

The second layer 52 is made of a semiconductor material or a dielectric material. Examples of the semiconductor material constituting the second layer 52 include Si and Ge. Examples of the dielectric material constituting the second layer 52 include SiO₂, SiN, Al₂O₃, Y₂O₃, Ta₂O₅, TiO₂, and ZnS. The second layer 52 can be made of a material having higher moisture resistance than the first layer 51. As an example, in the present embodiment, the second layer 52 is made of Si. Note that, a material of the base layer 56 can be selected from, for example, a material similar to the material of the second layer 52.

The third layer 53 has a rectangular shape as viewed from the first direction D1. The third layer 53 covers the second layer 52 as viewed from the first direction D1. More specifically, the third layer 53 includes a fourth portion 53a, a fifth portion 53b, and a sixth portion 53c. The fourth portion 53a extends so as to cover the first portion 52a of the second layer 52. The fifth portion 53b is connected to an end portion of the fourth portion 53a in the second direction D2, and extends along the first direction D1 from an end portion of the fourth portion 53a so as to cover the second portion 52b of the second layer 52. The sixth portion 53c is connected to an end portion of the fifth portion 53b on a side opposite to a connection portion with the fourth portion 53a, and extends toward a side (outside) opposite to the first layer 51 in the second direction D2 (and the third direction D3). Consequently, in the third layer 53, a step is formed between the fourth portion 53a and the sixth portion 53c.

The sixth portion 53c is arranged so as to face the third portion 52c of the second layer 52. In the present embodiment, the sixth portion 53c is in contact with the third portion 52c. In addition, in the present embodiment, the third layer 53 is an outermost layer of the optical branching film 50 and has a surface 50s of the optical branching film 50. That is, the third layer 53 forms the surface 50s of the optical branching film 50 facing the side opposite to the first surface 34a, and is in contact with the adhesive member 40. The third layer 53 is, for example, an oxide layer, and is made of SiO₂ as an example.

The fourth layers 54a and 54b have a rectangular shape as viewed from the first direction D1. The fourth layers 54a and 54b cover the first layer 51 as viewed from the first direction D1. The fourth layers 54a and 54b are flat layers. The fourth layers 54a and 54b can be made of, for example, one of Si, Ge, SiN, and ZnS. In addition, the fourth layers 54a and 54b can be made of the same material as the second layer 52. In the present embodiment, the fourth layers 54a and 54b are made of Si as an example.

The fifth layers 55a and 55b have a rectangular shape as viewed from the first direction D1. The fifth layers 55a and 55b cover the first layer 51 and the fourth layers 54a and 54b as viewed from the first direction D1. The fifth layers 55a and 55b can be made of, for example, one of SiO₂, Al₂O₃, TiO₂, Y₂O₃, and Ta₂O₅. In the present embodiment, the fifth layers 55a and 55b are made of, for example, SiO₂. As an example, the fourth layers 54a and 54b can be made of a first material (for example, Si) that has not been subjected to an oxidation treatment, and the fifth layers 55a and 55b can be oxide layers made of a material (for example, SiO₂) obtained by subjecting the first material to an oxidation treatment.

The adhesive member 40 includes a first adhesive portion 41 and a second adhesive portion 42. The first adhesive portion 41 is arranged (fills) in a region facing the first portion 52a of the second layer 52 (that is, the fourth portion 53a of the third layer 53) in a region sandwiched between the first surface 34a and the second surface 35a of the optical branching film 50, and is bonded to the second surface 35a and the surface 50s in the region. The second adhesive portion 42 is arranged (fills) in a region facing the second portion 52b of the second layer 52 (that is, the fifth portion 53b of the third layer 53) and the third portion 52c of the second layer 52 (that is, the sixth portion 53c of the third layer 53) in a region sandwiched between the first surface 34a and the second surface 35a of the optical branching film 50, and is bonded to the second surface 35a and the surface 50s in the region. The first adhesive portion 41 and the second adhesive portion 42 are integrally formed with each other. Consequently, the adhesive member 40 is formed so as to fill a step portion of the optical branching film 50, and is bonded to the first surface 34a and the second surface 35a via the optical branching film 50.

As described above, the optical branching film 50 includes a relatively thick effective area 50p formed by stacking the first layer 51, the second layer 52, the third layer 53, the fourth layers 54a and 54b, and the fifth layers 55a and 55b, and a relatively thin annular non-effective area 50r formed outside the effective area 50p so as to surround the effective area 50p and formed by stacking the second layer 52 and the third layer 53.

Note that, the optical surface 33c of the optical block 34 and the optical surface 33b of the optical block 35 constitute a bottom surface 3s of the beam splitter 3. The bottom surface 3s is a contact surface that comes into contact with an external member (here, the light transmissive member 112) when the beam splitter 3 is mounted on the external member.

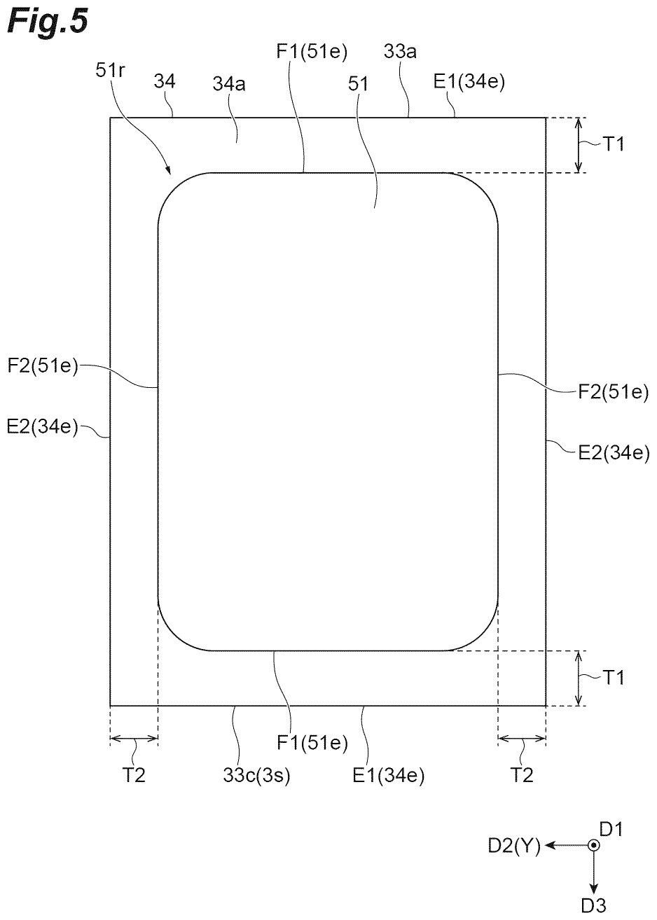

FIG. 5 is a schematic view illustrating a case where the first surface and the first layer illustrated in FIG. 4 are viewed from the first direction. As illustrated in FIGS. 4 and 5, the first surface 34a of the optical block 34 has a rectangular shape that is elongated in the third direction D3 than in the second direction D2 as viewed from the first direction D1. Accordingly, an outer edge 34e (that is, an outer edge of the optical block 34 as viewed from the first direction D1) of the first surface 34a includes a pair of short sides E1 parallel to each other and a pair of long sides E2 extending in a direction intersecting the short sides E1 and parallel to each other. One short side E1 is a first side corresponding to the bottom surface 3s (optical surface 33c) that faces (comes into contact with) an external member when the beam splitter 3 is mounted on the external member. The other short side E1 corresponds to the optical surface 33a serving as an incident surface of the laser light L10 in the beam splitter 3 and as an emission surface of the interference light L1 and L11.

Similarly, the first layer 51 of the optical branching film 50 has a rectangular shape that is elongated in the third direction D3 than in the second direction D2 as viewed from the first direction D1. Accordingly, the outer edge 51e of the first layer 51 includes a pair of short sides F1 parallel to each other and a pair of long sides F2 extending in a direction intersecting the short sides F1 and parallel to each other. Each of the short sides F1 faces each of the short sides E1 of the first surface 34a and extends in parallel to the short side E1. Each of the long sides F2 faces each of the long sides E2 of the first surface 34a and extends in parallel to the long side E2. A corner 51r of the first layer 51 where the short side F1 and the long side F2 intersect is chamfered, and is formed in an arc shape protruding outward from the first layer 51 in this case.

As viewed from the first direction D1, a distance T1 between the short side F1 of the first layer 51 and the outer edge 34e of the first surface 34a is larger than a distance T2 between the long side F2 of the first layer 51 and the outer edge 34e of the first surface 34a. The distance T1 is a distance between each of the short sides F1 and each of the short sides E1 of the first surface 34a facing each of the short sides F1. In addition, the distance T2 is a distance between each of the long sides F2 and each of the long sides E2 of the first surface 34a facing each of the long sides F2.

Note that, the first portion 52a of the second layer 52, the fourth portion 53a of the third layer 53, the fourth layers 54a and 54b, and the fifth layers 55a and 55b, that is, the effective area 50p of the optical branching film 50 also have a shape similar to the first layer 51 as viewed from the first direction D1. In addition, although not illustrated in FIG. 5, the second layer 52 and the third layer 53 reach (but may not reach) the outer edge 34e of the first surface 34a in the present embodiment. Accordingly, in the present embodiment, the optical branching film 50 is formed on the entire first surface 34a.

In addition, in the beam splitter 3, a film having an optical function such as a reflection film or an antireflection film can be formed on each surface. For example, in the beam splitter 3, an antireflection film can be formed on the optical surface 33d serving as an incident surface of one incident light (measurement light L0) and the optical surface 33a serving as an incident surface of another incident light (laser light L10). In addition, in the beam splitter 3, a reflection film that reflects light transmitted through the optical branching film 50 can be formed on the second mirror surface 32 (third surface) positioned on a side opposite to the optical surface 33d via the first mirror surface 31 (optical branching film 50). Further, in the beam splitter 3, antireflection films can be formed on the optical surfaces 33b and 33c which are emission surfaces for emitting the light reflected by the optical branching film 50 to the outside.

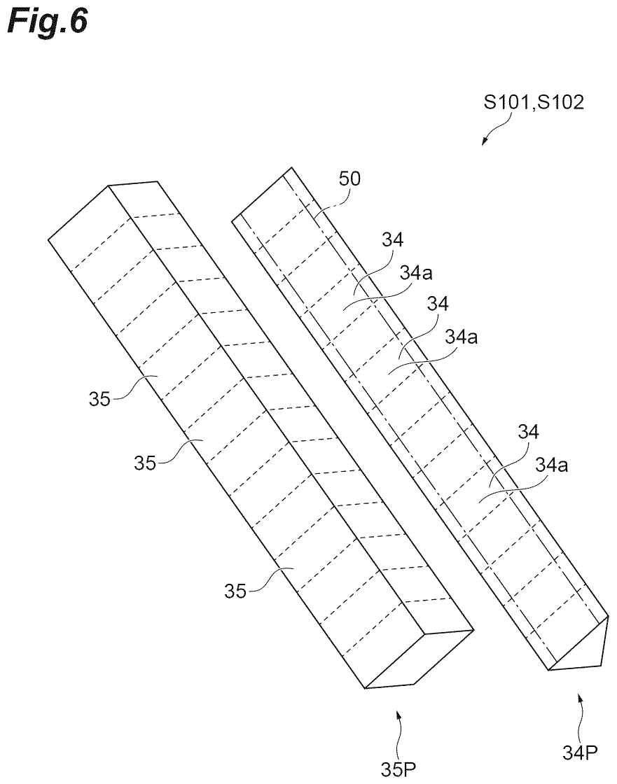

Subsequently, one embodiment of a beam splitter manufacturing method for manufacturing the above beam splitter 3 will be described. FIGS. 6 to 8 are diagrams illustrating one step of the beam splitter manufacturing method. As illustrated in FIG. 6, first, a first member 34P and a second member 35P are prepared (step S101, first step). The first member 34P is a member including a plurality of optical blocks 34 continuously arrayed in one direction, and the second member 35P is a member including a plurality of optical blocks 35 continuously arrayed in one direction. In other words, the first member 34P includes a plurality of portions to be the optical blocks 34 by cutting in step S104 to be described later, and the second member 35P includes a plurality of portions to be the optical blocks 35 by cutting in step S104 to be described later.

Subsequently, the optical branching film 50 is formed on the first surface 34a of each of the plurality of optical blocks 34 included in the first member 34P (step S 102, second step). Here, the optical branching film 50 is collectively formed on the plurality of first surfaces 34a continuous in one direction. At this time, the optical branching films 50 adjacent to each other may be connected in the non-effective area 50r or may be separated from each other.

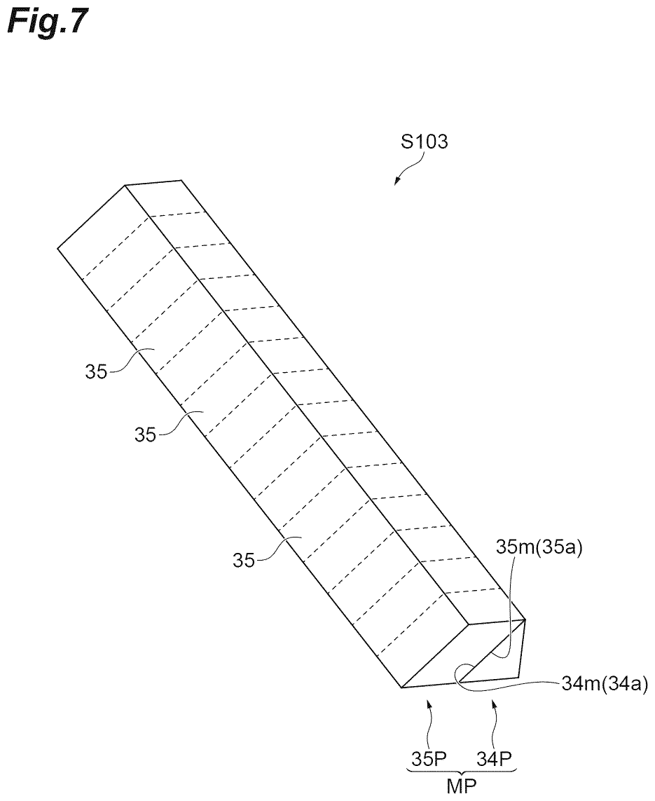

Subsequently, as illustrated in FIG. 7, the first member 34P and the second member 35P are bonded by the adhesive member 40 (step S103, third step). At this time, the first member 34P and the second member 35P are arranged and bonded such that a surface 34m including the plurality of first surfaces 34a of the first member 34P and a surface 35m including the plurality of second surfaces 35 a of the second member 35P face each other. Consequently, the optical branching film 50 is interposed between each of the first surfaces 34a and each of the second surfaces 35a, and a structure MP including a plurality of beam splitters 3 is formed.

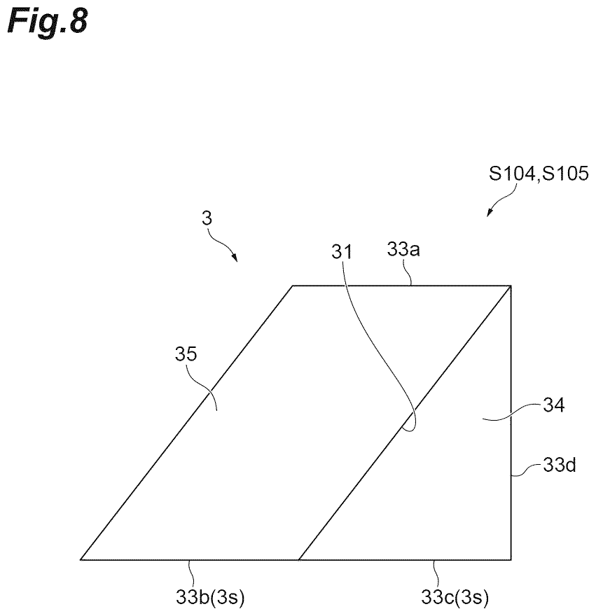

Subsequently, as illustrated in FIG. 8, the plurality of beam splitters 3 are obtained from the structure MP by dividing the structure MP by, for example, cutting (step S104, fourth step). Note that, between step S103 and step S104, a step of polishing a surface of the structure MP (step S105, fifth step) may be performed. In step S105, at least the bottom surface 3s (optical surfaces 33b and 33c) that comes into contact with the external member when the beam splitter 3 is mounted on the external member can be polished. In addition, step S105 may be performed after step S104. That is, after step S104, at least the surface such as the bottom surface 3s (optical surfaces 33b and 33c) may be polished with respect to the beam splitter 3 obtained by dividing the structure MP.

As described above, in the beam splitter 3, the optical block 34 and the optical block 35 are bonded to each other by the adhesive member 40 in a state where the optical branching film 50 is interposed therebetween. The optical branching film 50 includes the first layer 51 formed on the first surface 34a of the optical block 34 facing the optical block 35, and the second layer 52 stacked on the first surface 34a and the first layer 51. Then, the second layer 52 includes the first portion 52a extending so as to cover an upper surface of the first layer 51, the second portion 52b extending from the first portion 52a so as to cover the side surface of the first layer 51, and the third portion 52c extending from the second portion 52b toward a side opposite to the first layer 51.

As described above, the side surface of the first layer 51 is covered with the second layer 52 at least in a region where the second portion 52b is present (in the present embodiment, the entire circumference of the side surface of the first layer 51 is covered with the second layer 52). As a result, the side surface of the first layer 51 is prevented from being exposed to the outside, and deterioration such as corrosion of the first layer 51 is suppressed. In addition, the upper surface of the first layer 51 is also covered with the first portion 52a of the second layer 52. Thus, the deterioration such as corrosion of the first layer 51 is also suppressed until the optical block 34 and the optical block 35 are bonded (at the time of manufacturing). Accordingly, according to the beam splitter 3, the deterioration of optical characteristics is suppressed.

Note that, in the beam splitter 3, the second layer 52 that contributes to the suppression of the deterioration of the first layer 51 is a layer constituting the optical branching film 50. Accordingly, as compared with a case where a protective film is formed separately from the optical branching film 50, simplification of the manufacturing step, cost reduction, and the like can be achieved. Further, in the beam splitter 3, the adhesive member 40 includes the first adhesive portion 41 arranged in the region facing the first portion 52a of the second layer 52 in the region sandwiched between the first surface 34a and the second surface 35a, and the second adhesive portion 42 arranged in the region facing the second portion 52b and the third portion 52c of the second layer 52 in the region. Thus, adhesion between the optical block 34 and the optical block 35 is strengthened.

In addition, in the beam splitter 3, the optical branching film 50 has the third layer 53 stacked on the first surface 34a, the first layer 51, and the second layer 52 along the first direction D1. The third layer 53 includes the fourth portion 53a extending so as to cover the first portion 52a of the second layer 52, the fifth portion 53b connected to the end portion of the fourth portion 53a in the second direction D2 and extending along the first direction DI so as to cover the second portion 52b of the second layer 52 from the end portion of the fourth portion 53a, and the sixth portion 53c connected to the end portion of the fifth portion 53b on a side opposite to the connection portion with the fourth portion 53a and extending toward a side opposite to the first layer 51 in the second direction D2. The sixth portion 53c is arranged so as to face the third portion 52c. Thus, the side surface of the first layer 51 is further covered with the third layer 53 at least in the region where the second portion 52b is present (in the present embodiment, in the entire circumference). In addition, the upper surface of the first layer 51 is also further covered with the third layer 53. As a result, the deterioration such as corrosion of the first layer 51 is reliably suppressed, and the deterioration of optical characteristics is reliably suppressed.

In addition, in the beam splitter 3, the third layer 53 may be the oxide layer, and forms the surface 50s of the optical branching film 50 facing the side opposite to the first surface 34a and is in contact with the adhesive member 40. In this case, oxidation of the second layer 52 is suppressed until the optical block 34 and the optical block 35 are bonded (at the time of manufacturing).

In addition, in the beam splitter 3, the optical branching film 50 includes the pair of fourth layers 54a and 54b arranged so as to sandwich the first layer 51 along the first direction D1, and the pair of fifth layers 55a and 55b arranged so as to sandwich the first layer 51 and the pair of fourth layers 54a and 54b along the first direction D1. Then, the first portion 52a of the second layer 52 is formed on the fifth layer 55b and is in contact with the fifth layer 55b. The optical branching film 50 may have such a multilayer structure.

In addition, in the beam splitter 3, the fourth layers 54a and 54b may be made of a first material, and the fifth layers 55a and 55b may be oxide layers made of a material obtained by subjecting the first material to the oxidation treatment. In this case, an increase in an absorption coefficient (reduction in reflectance and transmittance) due to the oxidation of the first layer 51 can be suppressed. In addition, oxidation of the fourth layers 54a and 54b can be suppressed until the second layer 52 is formed (at the time of manufacturing).

In addition, in the beam splitter 3, the fourth layers 54a and 54b may be made of one of Si, Ge, SiN, and ZnS, and the fifth layers 55a and 55b may be made of one of SiO₂, Al₂O₃, TiO₂, Y₂O₃, and Ta₂O₅. As described above, the materials of the fourth layer and the fifth layer may be selected from these materials.

In addition, in the beam splitter 3, the fourth layers 54a and 54b may be made of the same material as the second layer 52. In this case, the number of film formation sources can be reduced in manufacturing the optical branching film 50, and the optical branching film 50 can be easily manufactured.

In addition, in the beam splitter 3, the outer edge 51e of the first layer 51 as viewed from the first direction D1 includes the short sides F1 and the long sides F2 extending in the direction intersecting the short sides F1. Then, as viewed from the first direction D1, the distance T1 between the short side F1 and the outer edge 34e of the first surface 34a is larger than the distance T2 between the long side F2 and the outer edge 34e of the first surface 34a. Thus, when the optical block 34 and the optical block 35 are bonded (at the time of manufacturing), even though positional displacement occurs in the direction intersecting the short side F1 of the first layer 51, the first layer 51 is suppressed from reaching an outer edge of the second surface 35a and being exposed.

In addition, in the beam splitter 3, the corner 51r of the first layer 51 as viewed from the first direction D1 may be formed in an arc shape. In this case, even though a corner of the optical block 34 or the optical block 35 is chipped, the first layer 51 is hardly exposed.

In addition, the beam splitter 3 includes the third surface (second mirror surface 32) positioned on the side opposite to the incident surface (optical surface 33d) via the first surface 34a, the optical branching film 50, and the second surface 35a. Then, the reflection film that reflects the light transmitted through the optical branching film 50 may be formed on the third surface. In this case, the light transmitted through the optical branching film 50 can be reflected in a predetermined direction.

In addition, in the beam splitter 3, the antireflection film may be formed on an emission surface that emits the light reflected by the optical branching film 50 to the outside. In this case, when the light reflected by the optical branching film 50 is emitted, the reflection on the emission surface is suppressed.

In addition, in the beam splitter 3, the antireflection film may be formed on the incident surface. In this case, the reflection of the incident light on the incident surface is suppressed.

In addition, in the beam splitter 3, the first layer 51 may be made of a metal material, and the second layer 52 may be made of a semiconductor material or a dielectric material. In this case, the deterioration such as corrosion of the first layer 51 made of a metal material is suppressed.

Further, in the beam splitter 3, the first layer 51 may be made of Ag or Al, and the second layer 52 may be made of one of Si, Ge, SiO₂, SiN, Al₂O₃, Y₂O₃, Ta₂O₅, TiO₂, and ZnS. In this case, the deterioration such as corrosion of the first layer 51 made of Ag or Al is suppressed.

Here, the beam splitter manufacturing method includes step S101 of preparing the first member 34P including the plurality of portions to be the optical blocks 34 and the second member 35P including the plurality of portions to be the optical blocks 35, step S102 of forming the optical branching film 50 on the first surface 34a of each of the plurality of optical blocks 34 included in the first member 34P, step S103 of bonding the optical block 34 and the optical block 35 by the adhesive member 40 via the optical branching film 50 to form the structure MP including the plurality of continuous beam splitters 3, and step S104 of dividing the structure MP to obtain the plurality of beam splitters 3 from the structure MP. According to this method, it is possible to efficiently manufacture the beam splitter capable of suppressing the deterioration of optical characteristics.

In addition, the beam splitter manufacturing method may include step S105 of polishing the surface of the structure MP between steps S103 and S104. Then, in step S105, at least the surface including the plurality of bottom surfaces 3s in the structure MP may be polished. In this case, the beam splitter 3 is easily mounted on the external member by flattening the contact surface (bottom surface 3s) of the beam splitter 3 with the external member. In addition, in a case where the contact surface is a light emission surface of the beam splitter 3, it is possible to reduce variations in the optical path length from the incident surface to the emission surface by polishing the contact surface which is the emission surface.

The above embodiment describes one aspect of the present invention. Accordingly, the present invention is not limited to the above embodiment, and can be voluntarily modified.

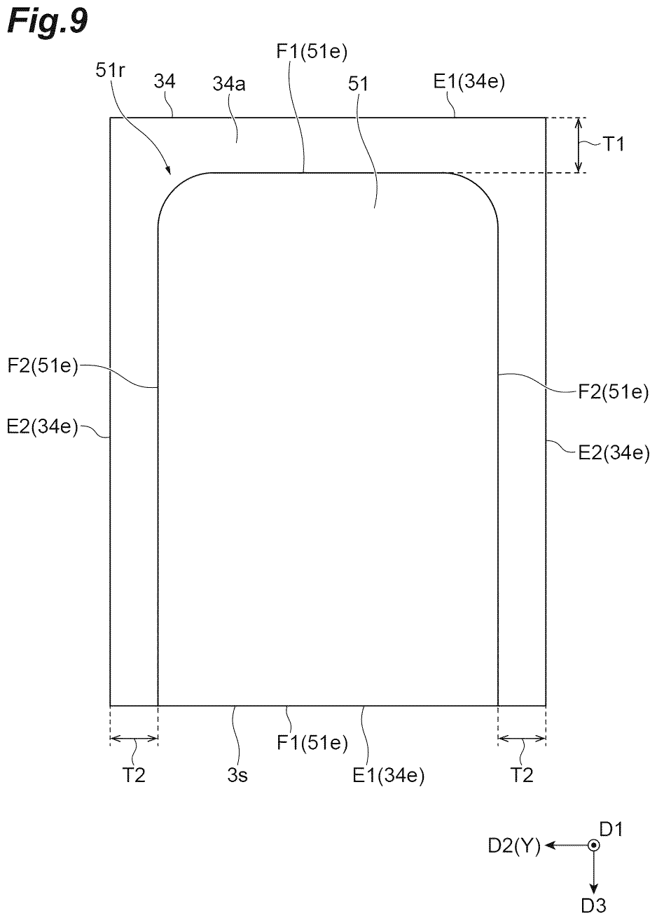

For example, as illustrated in FIG. 9, in the beam splitter 3, the outer edge 34e of the first surface 34a includes a first side (one corresponding to the bottom surface 3s of the pair of short sides E1) facing the external member side when the beam splitter 3 is mounted on the external member. Then, the first layer 51 may extend such that a part (one of the short sides F1 on the bottom surface 3s side) of the outer edge 51e of the first layer 51 overlaps the first side as viewed from the first direction D1. That is, the first layer 51 may extend to an outer edge of the optical block 34 on the bottom surface 3s side. In this case, the first layer 51 is formed wider, and a wider effective area 50p can be formed. On the other hand, a part of the outer edge 51e of the first layer 51 reaches the first side of the outer edge 34e of the first surface 34a, and the first side is a side facing (contacting) the external member when the beam splitter 3 is mounted on the external member. Accordingly, the part of the outer edge 51e of the first layer 51 is prevented from being exposed to the outside.

In addition, the stacked structure of the optical branching film 50 in the above embodiment can also be voluntarily deformed within a range in which the first layer 51 and the second layer 52 are maintained. For example, at least one layer other than the first layer 51 and the second layer 52 may be omitted, or another layer may be added.

In addition, the corner 51r of the first layer 51 may not be chamfered, may be chamfered, or may not have an arc shape. In addition, the shape of the first layer 51 as viewed from the first direction D1 is not limited to a rectangular shape elongated in one direction, and may be a square shape or another shape. The same applies to the other layers of the optical branching film 50 and the shape of the first surface 34a.

### Industrial Applicability

A beam splitter capable of suppressing deterioration of optical characteristics and a beam splitter manufacturing method are provided.

### REFERENCE SIGNS LIST

3 beam splitter
34 optical block (first light transmissive member)
34a first surface
35 optical block (second light transmissive member)
35a second surface
40 adhesive member
41 first adhesive portion
42 second adhesive portion
50 optical branching film
51 first layer
52 second layer
52a first portion
52b second portion
52c third portion
53 third layer
53a fourth portion
53b fifth portion
53c sixth portion
54a, 54b fourth layer
55a, 55b fifth layer
E1, F1 short side
E2, F2 long side

1. A beam splitter for branching incident light into a plurality of different components and emitting the components, the beam splitter comprising:
a first light transmissive member that has a first surface and has transmissivity with respect to the incident light;
a second light transmissive member that has a second surface and has transmissivity with respect to the incident light;
an optical branching film that has a function of branching the incident light into the plurality of components; and
an adhesive member configured to bond the first light transmissive member and the second light transmissive member,
wherein the first light transmissive member and the second light transmissive member are arranged such that the first surface and the second surface face each other with the optical branching film interposed therebetween,
the optical branching film includes
a first layer formed on the first surface, and
a second layer stacked on the first surface and the first layer along a first direction intersecting the first surface,
the second layer includes
a first portion extending so as to cover an upper surface of the first layer on a side opposite to the first surface,
a second portion connected to an end portion of the first portion in a second direction intersecting the first direction and extending along the first direction from the end portion of the first portion so as to cover a side surface of the first layer, and
a third portion connected to an end portion of the second portion on a side opposite to a connection portion with the first portion and extending toward a side opposite to the first layer in the second direction, and
the adhesive member includes
a first adhesive portion arranged in a region facing the first portion of the second layer in a region sandwiched between the first surface and the second surface, and
a second adhesive portion formed integrally with the first adhesive portion and arranged in a region facing the second portion and the third portion of the second layer in the region sandwiched between the first surface and the second surface.

2. The beam splitter according to claim 1,
wherein the optical branching film includes a third layer stacked on the first surface, the first layer, and the second layer along the first direction,
the third layer includes
a fourth portion extending so as to cover the first portion of the second layer,
a fifth portion connected to an end portion of the fourth portion in the second direction and extending along the first direction from the end portion of the fourth portion so as to cover the second portion of the second layer, and
a sixth portion connected to an end portion of the fifth portion on a side opposite to a connection portion with the fourth portion and extending toward a side opposite to the first layer in the second direction, and
the sixth portion is arranged to face the third portion.

3. The beam splitter according to claim 2,
wherein the third layer is an oxide layer, and
the third layer forms a surface of the optical branching film facing a side opposite to the first surface, and is in contact with the adhesive member.

4. The beam splitter according to claim 1,
wherein the optical branching film includes
a pair of fourth layers arranged so as to sandwich the first layer along the first direction, and
a pair of fifth layers arranged so as to sandwich the first layer and the pair of fourth layers along the first direction, and
the first portion of the second layer is formed on the fifth layer and is in contact with the fifth layer.

5. The beam splitter according to claim 4,
wherein the fourth layer is made of a first material, and
the fifth layer is an oxide layer made of a material obtained by subjecting the first material to an oxidation treatment.

6. The beam splitter according to claim 4,
wherein the fourth layer is made of one of Si, Ge, SiN, and ZnS, and
the fifth layer is made of one of SiO₂, Al₂O₃, TiO₂, Y₂O₃, and Ta₂O₅.

7. The beam splitter according to claim 4, wherein the fourth layer is made of the same material as the second layer.

8. The beam splitter according to claim 1,
wherein an outer edge of the first layer as viewed from the first direction includes short sides and long sides extending in a direction intersecting the short sides, and
as viewed from the first direction, a distance between the short side and an outer edge of the first surface is larger than a distance between the long side and the outer edge of the first surface.

9. The beam splitter according to claim 1,
wherein an outer edge of the first surface includes a first side facing an external member when the beam splitter is mounted on the external member, and
the first layer extends such that a part of an outer edge of the first layer overlaps the first side as viewed from the first direction.

10. The beam splitter according to claim 1, wherein a corner of the first layer as viewed from the first direction is formed in an arc shape.

11. The beam splitter according to claim 1, further comprising:
an incident surface of the incident light; and
a third surface positioned on a side opposite to the incident surface via the first surface, the optical branching film, and the second surface,
wherein a reflection film configured to reflect light transmitted through the optical branching film is formed on the third surface.

12. The beam splitter according to claim 1, further comprising:
an emission surface configured to emit light reflected by the optical branching film to an outside,
wherein an antireflection film is formed on the emission surface.

13. The beam splitter according to claim 1, further comprising:
an incident surface of the incident light,
wherein an antireflection film is formed on the incident surface.

14. The beam splitter according to claim 1,
wherein the first layer is made of a metal material, and
the second layer is made of a semiconductor material or a dielectric material.

15. The beam splitter according to claim 1,
wherein the first layer is made of Ag or Al, and
the second layer is made of one of Si, Ge, SiO₂, SiN, Al₂O₃, Y₂O₃, Ta₂O₅, TiO₂, and ZnS.

16. A beam splitter manufacturing method for manufacturing the beam splitter according to claim 1, the method comprising:
a first step of preparing a first member including a plurality of portions to be the first light transmissive members and a second member including a plurality of portions to be the second light transmissive members;
a second step of forming the optical branching film on the first surface of each of the plurality of portions, which are included in the first member and become the first light transmissive member, after the first step;
a third step of bonding the first member and the second member by the adhesive member via the optical branching film to form a structure including a plurality of the continuous beam splitters after the second step; and
a fourth step of dividing the structure to obtain a plurality of the beam splitters from the structure after the third step.

17. The beam splitter manufacturing method according to claim 16, further comprising:
a fifth step of polishing a surface of the structure between the third step and the fourth step,
wherein the beam splitter includes a contact surface configured to come into contact with an external member when the beam splitter is mounted on the external member, and
in the fifth step, at least a surface including a plurality of the contact surfaces in the structure is polished.
